(19) United States
(12) Patent Application Publication
(10) Pub. No.: US 2003/0156531 A1
(43) Pub. Date: Aug. 21, 2003

(54) Disk data storage media with edge track data surface, methods to manufacture, exploit and convert conventional disk media to that having an edge track data surface

(75) Inventor: Gary W. Ferguson, Burnaby (CA)

Correspondence Address: Charles H. DeVoe, Kolisch, Hartwell, Dickinson, McCormack & Heuser, 200 Pacific Building, 520 S.W. Yamhill Street, Portland, OR, 97204, US

(73) Assignee: G6 Science Corporation

(21) Appl. No.: 10/079,449

(22) Filed: Feb. 19, 2002

(51) Int. Cl. G11B 3/70; G11B 5/84; G11B 7/26

(52) U.S. Cl. 369/272

(57) ABSTRACT

The present invention relates to disk data storage media including magnetic, magneto-optical and optical media such as CD-ROM, CD-RW, DVD, DVD-RAM, Mini-disks and other disk media. It provides for new disk media featuring a data storage surface on the edge of the disk. This novel edge track data surface may be marked, inscribed or recorded during manufacture or this new data surface may be created and utilized later. In addition, methods to manufacture, exploit and convert conventional disk media to that having an edge track data surface are taught herein.

### FIELD OF INVENTION

The present invention relates to disk data storage media including magnetic, magneto-optical and optical media such as CD-ROM, CD-RW, DVD, DVD-RAM, Mini-disks and other disk media. It provides for new disk data media featuring a data storage surface on the edge of the disk.

### DESCRIPTION OF PRIOR ART

Disk data storage media is ubiquitous within the computer and entertainment industry and a broad range of variations exist. Disk media may be pre-recorded, recordable or re-writable on one or both disk surfaces, and in the case of optical disks, the two opposed disk surfaces may each have single or multi-layers for data storage.

In addition to data, disk media typically carries other information on the disk surface such as title, content or manufacturing information in the form of labels, barcodes, markings, printing, etc. U.S. Pat. No. 6,058,086, for example, teaches writing on the outer surface area of an optical disk, an area which is not used during manufacture of a pre-recorded disk.

The expanding need to store and retrieve mass information has led to the development of multi-disk players, audio-video juke boxes or more generally, disk management systems. Such disk management systems typically employ carousels, disk carriers, ring configurations or spindle stacks of disk media. Examples of disk management systems, configurations and exploitations are taught in U.S. Pat. Nos. 4,809,255; 5,022,020; 5,077,717; 5,099,465; 5,146,451; 5,189,656; 5,195,794; 5,319,621; 5,473,585; 5,568,455; 5,617,385; 5,708,643 and 5,777,957.

Within disk management systems, there is a growing need to locate a particular disk or to gather information about the contents of a disk. Access to surface information, such as a printed label, is often inhibited by the close proximity of disks. Home users of multi-disk CD and DVD players often must transcribe disk content information such as title, artists, play lists etc. Disk management systems often depend on the physical location of a specific disk and support data access by maintaining a cross index to disk content in a database. Unfortunately, the simple act of removing or relocating a disk can undermine significant organizational efforts. While the penalty for confusing pre-recorded media may be ‘Rap on the eardrums’, rather the requested mellow, jazz arpeggios of John Pizzarelli, for recordable and re-writable disk media such confusion has more serious consequences.

Methods of inscribing data on cylinders are known and some considerations are taught in U.S. Pat. No. 5,886,792 entitled “Engraver for defining/generating edges or edge signals”.

A method to locate data on magnetic tapes, such as cassettes, is taught in U.S. Pat. No. 5,991,111 entitled “Edge recorded magnetic tape and read head.” This reference teaches an elongated, thicker, magnetic tape base with a layer of magnetic material coated on both the front face and upper edge of the base film so as to facilitate data access for magnetic tape. It is noteworthy that this patent specifically teaches against similar considerations for disk media, which does not share the same limitations.

These and other limitations with existing disk media are widely acknowledged and addressed, to varying degrees, by prior art. One approach is taught in U.S. Pat. No. 6,111,824 entitled “Apparatus for gathering and displaying information about the contents of one or more optical disks within an optical disk player” as well as U.S. Pat. No. 6,188,651 entitled “Information retrieval system including auto-changer for auto changing information-recorded media”. Quality testing during manufacture is taught in U.S. Pat. No. 6,058,086 entitled “Method and apparatus for testing quality of an optical disk media”. Additionally, U.S. Pat. No. 5,319,621 entitled “Device for storing and reading flat data media” teaches a stack of media with spacers marked with an identifying ribs to allow a vertical count-down to access a particular disk. U.S. Pat. No. 5,568,455 entitled “System and method for the storage and retrieval of off-line preformatted optical media” also recognizes this need and addresses it by encasing optical disks in cartridges coded to provide management information. Similarly, U.S. Pat. No. 5,382,776 entitled “Combination of an optical-disk and barcode memory medium for use with an optical disk playback apparatus, having control programs stored in the optical-disk and specified by barcodes stored in the barcode medium” teaches the use of barcodes to store control programs. Yet another means to access disk content is taught in U.S. Pat. No. 6,137,767 entitled “Optical disk memory content display apparatus system and display control method”. Here, IC memory-in-disk is imbedded in the inner non-information area of a disk. Yet another means of providing disk content information is taught in U.S. Pat. No. 5,634,031 entitled “Optical disk system having table-of-contents information data”, wherein the table-of-contents is written to a user's non-recording area of the disk.

There remains a need for a robust solution to these ongoing concerns.

### SUMMARY OF INVENTION

The present invention is a new disk data storage media featuring a novel data storage surface on the edge of the disk. This new data surface on the edge of the disk may be imparted with pre-recorded data or this new data surface may be exploited as a fully functional data surface.

The new device, methods to manufacture, exploit and convert existing disk media to that having a data surface on the edge are described herein.

Accordingly, the present invention provides disk data storage media comprising a disk having first and second disk surfaces and an edge surface with at least one of said first and second disk surfaces and said edge surface being formed to store data.

The present invention also provides for disk data storage media having first and second disk surfaces and an edge surface, the improvement comprising forming of the disk edge surface to store data.

In a further aspect, the present invention provides a method of storing additional data on disk data storage media in the form of a disk with first and second data storage surfaces comprising storing data on the edge surface of the disk.

In a still further aspect the present invention provides a method of providing additional data storage capacity on disk data storage media in the form of a disk with first and second disk surfaces, comprising the step of forming a data storage surface on the edge surface of the disk.

In addition to overcoming limitations with existing disk data storage media, the present invention can be exploited to inscribe manufacturing information, provide updated content, detect tilt, disk vibration, monitor/control disk rotation speed, implement data protection schemes and improve data access, to mention a few advantages.

### BRIEF DESCRIPTION OF DRAWINGS

Aspects of the present invention are illustrated, merely by way of example, in accompanying drawings in which:

FIG. 1 shows a disk management system as a ring configuration with existing disk media and the present invention represented with edge data surface marked with redundant barcodes;

FIG. 2 shows a vertical stack of disk media with the edge track data surface of the present device being inventoried by a vertically tracking reader;

FIGS. 3a and b show preparation and application of a data recording layer to a disk edge so as to create a data surface;

FIG. 4 shows a disk according to the present invention recorded with multiple tracks of data alongside non-data in the form of strobe marks;

FIGS. 5-12 show various configurations of the edge surface of a disk for exploitation as edge track data surfaces;

FIG. 13 illustrates a method of manufacturing a disk according to the present invention by applying an edge data surface to an existing disk;

FIG. 14 shows another method of manufacturing a disk according to the present invention by applying an edge data surface into a groove formed in the disk edge.

FIG. 15 shows a still further method of manufacturing a disk according to the present invention by sandwiching an edge surface for data storage between two disk platters; and

FIG. 16 shows yet another method to manufacture the new device involving mounting together two disk platters of slightly different diameter such than one platter fits within the other.

### DETAILED DESCRIPTION OF PREFERRED EMBODIMENTS

In one aspect, the present invention provides a novel disk data storage media featuring a data storage surface on the edge of the disk. This new edge data surface may be imparted with pre-recorded data or may be exploited as a read/write data surface. Methods to manufacture and convert existing disk media to include a data surface on the edge surface of the disk are described as well as other advantages and means of exploiting the present invention.

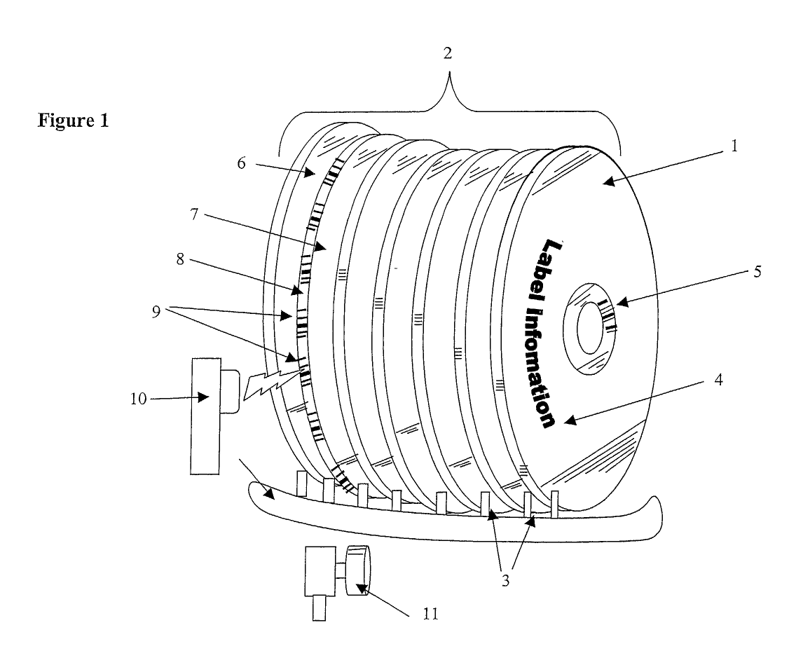

FIG. 1 shows schematically a typical disk management system configured as a horizontally aligned stack (2) of disk media. Often such a stack of disks is arranged in an annular configuration. Access to surface information on disks (1), such as title label (4) or bar-coded manufacturing information (5) is impeded by the narrow gap (6) between adjacent disks. The disks are generally held apart and supported by grooves or fingers (3). Disk media (7) according to the present invention comprise a disk having first and second disk surfaces and an edge surface (8) with at least one of the first and second disk surfaces and the edge surface being formed to store data. In the example of FIG. 1, edge surface 8 is inscribed with data in the form of redundant barcodes (9) readable by barcode reader (10). Instead of redundant barcodes, disks (7) can be notched or otherwise indexed to pre-position the barcode for the reader. Such pre-positioning could be performed by the disk player assembly, or for example, by a device such as rotating wheel (11) which is positionable to contact and rotate the disk to the desired position. Alternatively, wheel (11) could be used to rotate the disk so as to facilitate the read/write of bar-coded information on the edge data surface. Bar-code schemes and methods of exploiting them are known. Some examples are taught in U.S. Pat. Nos. 4,845,348; 5,056,429; 5,120,940; 5,382,776; 6,276,606; 6,351,203 and 6,158,660. The use of magnetic inks in bar codes is taught in U.S. Pat. No. 6,324,353. Methods to locate index marks are also known. For example, U.S. Pat. No. 6,342,705 teaches how to locate index marks (a flat area or notch) on the edge of a semiconductor wafer to permit reliable positioning.

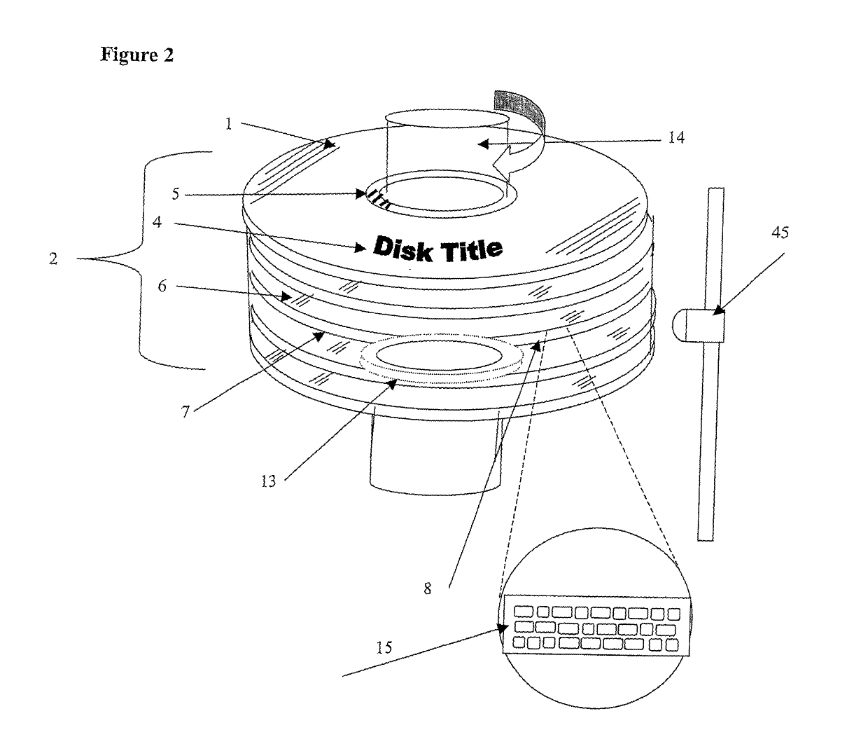

FIG. 2 shows a typical disk management system with a vertical stack of disk media rotating on a common spindle (14). The disks (1) may be in direct contact or may be held apart by spacers (13). As in the previous example, access to surface information such as the disk title (4) and manufacturing barcodes (5) is impeded by the narrow gap (6) created by the close proximity of the disks making it difficult to read that surface information throughout the stack. A disk (7) according to the present invention imparted with multiple tracks of pre-recorded data (15), such as a table-of-contents, on the edge surface (8), is read by a vertical tracking reader (45). Such read/write apparatus are known. Another more recent example of an optical disk reader is taught in U.S. Pat. No. 5,251,193 entitled “Solid state optical disk reader”.

A data storage edge surface according to the present invention can be formed on an existing conventional data storage disk by preparing the edge surface of the disk and then applying a surface for storage of data to the edge surface. Preferably, preparation involves rotating the disk adjacent abrading equipment to smooth the edge surface.

Applying a surface for storage of data can involve coating of the smoothed edge surface with a surface to store data. Coating can comprise spraying the data storage surface onto the edge surface. Alternatively, applying a surface for data storage can involve bonding material with a data storage surface to the edge surface.

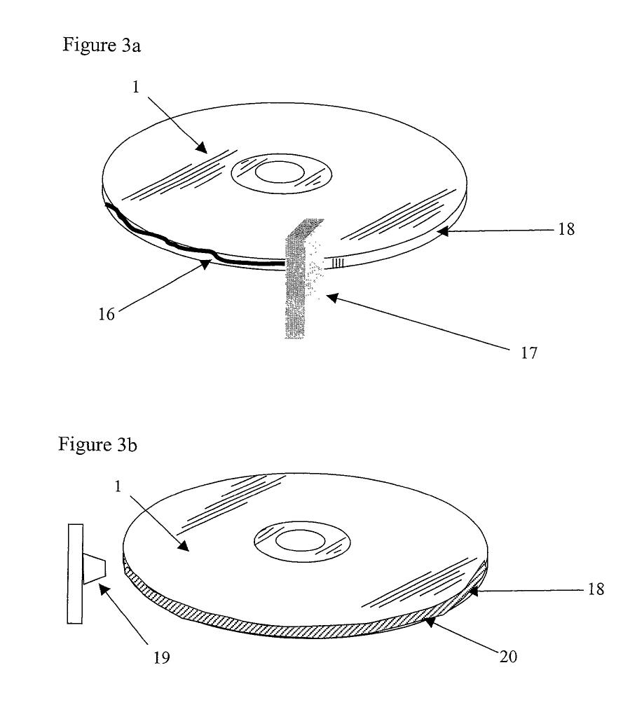

FIG. 3a shows the rough edge (16) of a disk (1) being abraded/polished by finishing device (17) so as to prepare edge surface (18) to act as a data storage surface. U.S. Pat. No. 5,986,982 teaches bonding two optical disks or surfaces (with a thickness half that of a normal optical disk), together to produce a high-density optical disk. This preparation step may be integrated into the manufacturing process or be applied to existing disk media. FIG. 3b shows the prepared edge (18) being layered by device (19) with a coating (20) to store data. Suitable coating methods and materials are known. U.S. Pat. No. 3,971,874 entitled “Optical information storage material and method of making it” teaches transparent substrates, an amorphous silicon layer and a protective coating. Amorphous materials employed in optical disks have two optical density states, a high and a low, which can be changed by electrical, optical or thermal energy. Such materials are disclosed in U.S. Pat. No. 4,064,531 entitled “Semiconductor device having a body of amorphous silicon” and are exploited further in U.S. Pat. No. 4,302,928 entitled “Updatable optical storage media”. Similarly, phase change materials for recording and reproducing information are taught in U.S. Pat. No. 6,288,997 entitled “Phase change optical disk media”. Other film layers, coatings and optical disk surfaces useful for application to the prepared disk edge surface (18) of the present invention are disclosed in: U.S. Pat. No. 4,837,130 entitled “Optical disk manufacturing method”; U.S. Pat. No. 6,077,582 entitled “Optical disc, process for producing the optical disc and its manufacture apparatus”; U.S. Pat. No. 4,837,130 and U.S. Pat. No. 6,077,582 are further examples. Reproduction schemes are also taught in U.S. Pat. No. 6,298,138 with spin coating taught in U.S. Pat. No. 6,058,086 and U.S. Pat. No. 6,203,849. Additionally, U.S. Pat. No. 6,058,086 teaches layering techniques for various substrates, reflective coatings and protective layers for optical disks. The patents mentioned above are incorporated herein by reference.

Using the techniques and materials disclosed in the above mentioned US patents, a disk according to the present invention can be manufactured with a disk edge surface that stores data magnetically, optically, or magneto-optically. Data can also be stored by marking the disk edge by inscribed markings. The disk edge surface can have data recorded according to various known physical, magnetic, kinetic, thermal and optical processes.

The disk edge surface can be formed to be both readable and writable or read only by applying known data storage surfaces and using known data storage techniques.

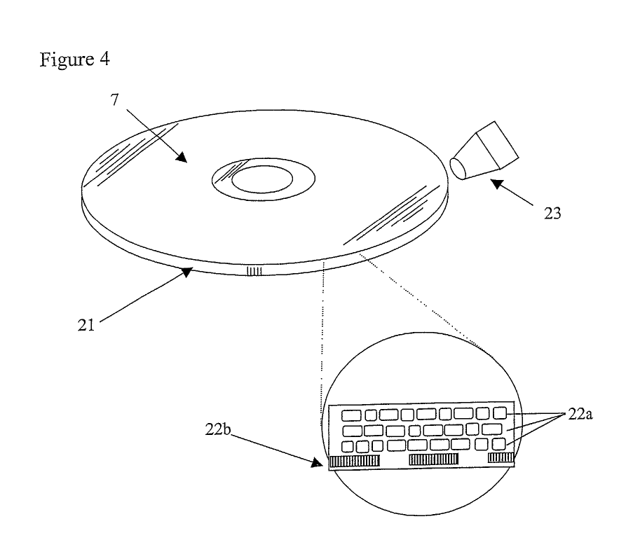

FIG. 4 shows another arrangement to exploit the edge data of the present invention. A disk (7) is formed with an edge surface (21) having multiple tracks of data (22a) alongside timing data (22b) in the form of strobe marks, for example. The timing data is used to permit monitoring of physical characteristics such as the tilt, rotation speed, vibration of the disk, for example. Timing data is read by monitoring/controlling device (23). The concept of encoding timing/servo information along with data is disclosed in U.S. Pat. No. 5,170,299 entitled “Edge servo for disk drive head positioner.”

Monitoring and controlling variations in the rotation speed of the disk can be used to effect unique forms of data encryption or protection. Such features, apparatus and considerations are taught and exploited to varying degrees for surface data as disclosed in U.S. Pat. No. 4,835,757 entitled “System for recording information onto disk medium”, U.S. Pat. No. 5,315,567 entitled “Optical disk formatting system using index mark detecting system”, U.S. Pat. No. 5,521,899 entitled “Optical disk apparatus for mechanically restricting the distance between and optical disk and head”, U.S. Pat. No. 5,634,031 entitled “Optical disk having table-of-contents information data”, U.S. Pat. No. 5,523,989 entitled “Optical disk drive having functions of detecting disk tilt from diffraction pattern of track and compensating disk tilt with use of comatic lenses”, U.S. Pat. No. 5,699,340 entitled “Method of correcting aberration due to optical disk tilt and apparatus therefore”, U.S. Pat. No. 5,901,132 entitled “Pickup head having two laser light sources for separately reading an optical disk with two recording layers”, U.S. Pat. No. 6,046,968 entitled “Rewritable optical disk having reference clock information permanently formed on the disk”, U.S. Pat. No. 6,111,826 entitled “Optical disk drive capable of controlling rotation speed of the disk based on detecting the vibration”, U.S. Pat. No. 6,131,138 entitled “Variable speed compact disk drive including an elastic buffer”, U.S. Pat. No. 6,154,482 entitled “Technique for setting speed of optical disk player according to condition of optical disk” and U.S. Pat. No. 6,178,154 entitled “Optical disk device having increased height at an outer periphery of the optical disk”.

A person skilled in the art will appreciate that the edge with a data storage surface also provides the opportunity to improve the performance of existing disk data storage media, including magnetic disks. For example, by monitoring/controlling disk rotation speed, appropriately encoded tracks could allow disk content or other data access information to be gathered independently. In some instances, it may be beneficial to perform these functions while the disk is coming up to speed, for example, thus facilitating data access. Similarly, quality control information, authenticity codes, encryption keys and other features implemented or exported to the edge track data surface could be made transparent to the user without impacting compatibility or functionality.

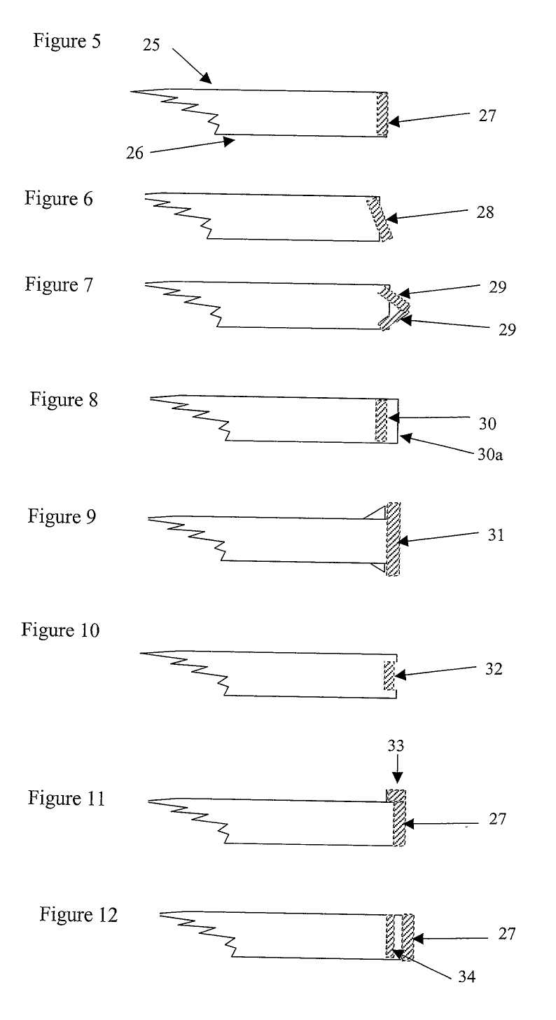

FIGS. 5-12 illustrate various embodiments of the disk of the present invention having differently formed edge surfaces to define a surface to receive data. It will be appreciated that embodiments that do not significantly affect compatibility with existing standards may be preferred.

FIG. 5 is a partial view in cross-section of the outer periphery of a disk having first surface (25) and second surface (26). One or both surfaces (25,26) are used to store data as is conventional. Edge surface (27) is formed as an additional surface for data storage.

FIG. 6 shows an edge surface for data storage which is enlarged to increase the area available for data storage. The enlarged disk edge surface is formed by creating an angled annular surface (28) extending from one of the first and second disk surfaces.

FIG. 7 illustrates a further example of an enlarged edge surface for data storage which includes a pair of opposed, angled surfaces (29) that define a generally triangular cross-section having an apex at the edge surface of the disk. Each surface (29) defines a separate edge data surface that could be exploited independently.

FIG. 8 shows an edge data surface in which the data surface (30) is covered and protected by a transparent layer (30a). Such a configuration can be achieved by forming a data surface on the inner surface of a ring or disk of transparent or translucent material which is then mounted about the periphery of a data disk. Similarly, protective coatings are commonly employed to protect data surface of optical disks from fingerprints, scratches etc.

It is possible to form an enlarged disk edge surface simply by increasing the thickness of the disk adjacent the disk edge. FIG. 9 shows an example of this in which the edge surface (31) for storing data is formed to be wider that the thickness of the disk to which the edge surface is mounted.

A data storage disk is illustrated in FIG. 10 in which the disk edge surface is formed to receive and retain material having a surface to store data. In the illustrated example, the disk edge surface is formed with a groove to receive a flexible band of material (32) to store data. Material (32) is preferably recessed into the edge of the disk.

FIG. 11 shows yet another configuration in which an enlarged disk edge surface is formed by an annular flange extending from at least one of the first and second disk surfaces. In the illustrated example, the annular flange comprises a new data storage surface (33) formed at the outer perimeter of the first surface of the disk and adjacent the edge surface (27). Both data surfaces (27) and (33) can be exploited, independently with appropriately positioned read/write heads for data.

FIG. 12 shows a disk storage media in which the edge surface is formed with at least two layers with each layer being adapter to store data. In the illustrated example, data storage layer (34) underlies data storage layer (27). A transparent layer separates the two data storage layers. A laser read/write unit that can be focussed at each layer is necessary to read or write the data to or from each data storage layer. U.S. Pat. No. 5,78,342 entitled “Apparatus and method for accessing data on multi-layered optical media” teaches such a method for a conventional disk surface. Similarly, U.S. Pat. No. 5,757,763 entitled “Optical information storage via amplitude modulation” teaches an alternative method of storing data by recessing two or more data layers on the surface of conventional disk media.

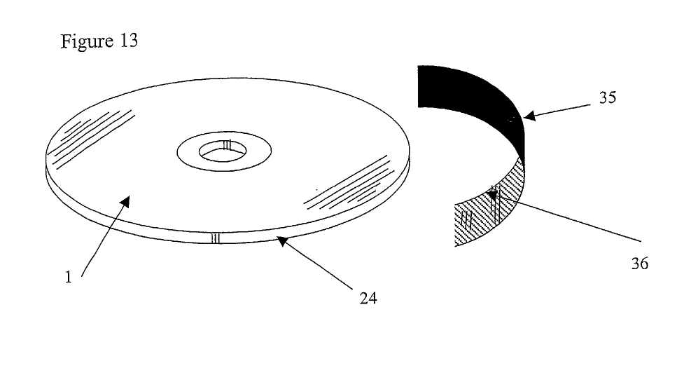

FIG. 13 shows a method of manufacturing or converting a conventional magnetic, magneto-optical or optical disk (1) to a disk according to the present invention. The method involves applying a data storage surface to the edge of the disk. For example, the data storage surface can comprise a flexible strip of material (35) with an appropriate coating for storing data (36) which is bonded to the outer edge of the disk (1). In a similar manner, the data storage surface can comprise a wire or wires, inscribed or inscribable with data which are bound to the disk edge to act as a data surface. The case of one or more wires mounted to the disk edge surface demonstrates that the edge data surface does not have to be a planar surface.

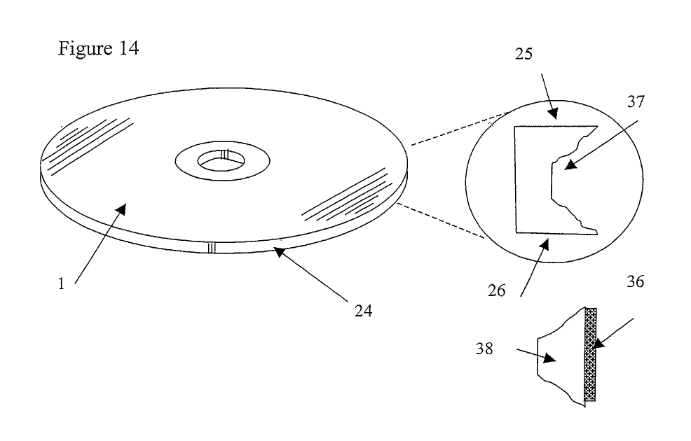

FIG. 14 illustrates in greater detail the method of forming an edge surface to store data using a groove (37) and a data storage material (36,38). The technique illustrated in FIG. 14 can be used in the manufacture of new disks or the conversion of existing disk data storage media to that having a data surface on the edge of the disk. The edge (24) of disk (1) is formed with a groove (37) to receive and retain a strip or annular ring (38) of material having an appropriate data storage coating (36). The material is preferably bonded to the receiving groove (37) surface to position the data storage coating (36) on the edge of the disk. Adhesives, pressure fitting, thermal expansion or other suitable techniques can be used to secure the annular ring of material (38) into groove (37).

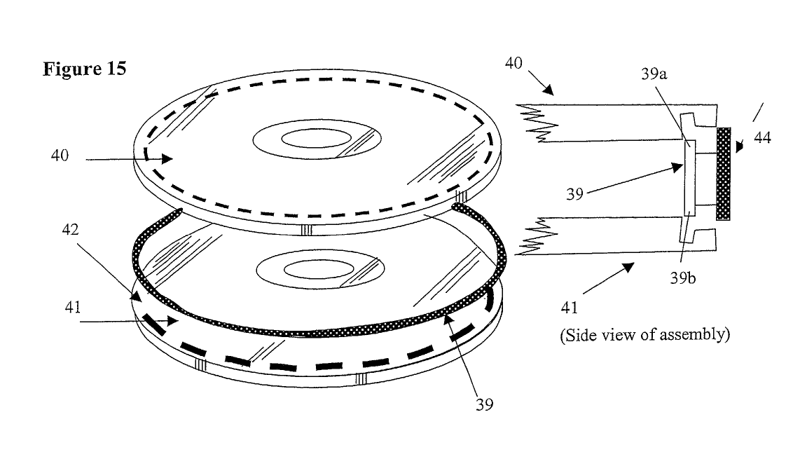

Another method of manufacturing the new disk data storage media of the present invention is illustrated in FIG. 15. In this case, the disk data storage media comprises a pair of disk platters (40,41) mounted back to back to define an annular perimeter space therebetween. An edge data storage member (39,44) is mounted in the perimeter space sandwiched between the disk platters to define an edge surface. The data storage member comprises an annular ring (39) with an appropriate coated surface (44) to store data. Ring (39) is sandwiched between an upper disk platter (40) and a lower disk platter (41) such that coated edge (44) for storing data is exposed between the disk platters for read/write access. To facilitate alignment of the assembly, annular grooves (42) are preferably formed in the adjacent surfaces of the disk platters to receive corresponding flanges (39a,39b) formed on ring (39). Ring (39) can be installed with pre-recorded data on data surface 44. Similarly, the edge of the adjoining structure can be pre-recorded or have inscribed data. A person skilled in the art will note that the annular ring (39) is itself, in this instance, a disk structure having a data surface on its edge. Similarly, two or more disks having data surfaces on their edges could be attached to form another configuration. Such a technique may be useful in manufacturing.

The use of annular rings as spacers and manufacturing concerns for the type of disk assembly illustrated in FIG. 15 are disclosed in U.S. Pat. No. 5,305,304 entitled “Optical information carrier having a spacer securely bonded between disks by adhesive” and this reference is incorporated herein by reference.

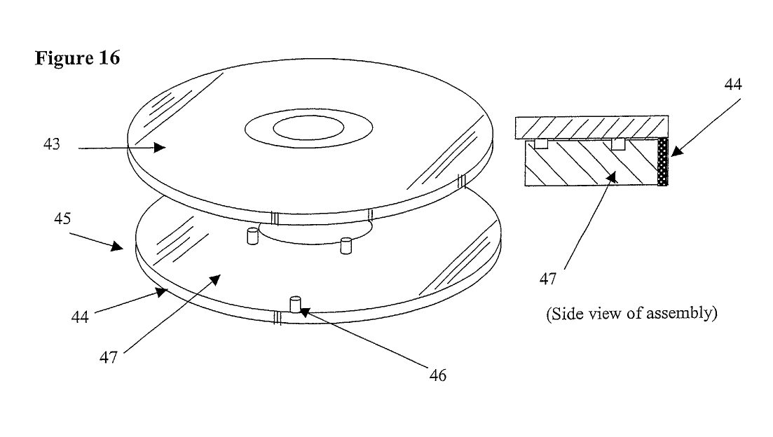

FIG. 16 shows a further disk manufacturing method for the present device. In this case, a slightly larger diameter upper disk platter (43) is bonded to a smaller diameter lower disk platter (47). Upper disk platter (43) is formed with a depending annular flange having a data storage surface (44) thereon which defines a circular cavity to receive lower disk platter (47), Platters (43,47) are positioned together with the aid of alignment pins (46). The technique of mounting together differently sized platters is known. For pre-recorded audio CDs, those skilled in the art will appreciate that lower platter (47) is commonly made of transparent material with audio data inscribed or recorded on the underside of upper platter (43). In use, the CD is read through the combined structure from beneath. The innovation of the present invention is the use of the edge surface of assembled disk to store data. A variety of data surfaces may be fashioned on the edge and be exploited accordingly.

A summary of manufacturing techniques are taught in U.S. Pat. No. 5,700,539 entitled “Thin film and interferometric optical disk media and mass production method for fabricating such a multi-layer CD” the disclosure of which is incorporated herein by reference.

It will be clear to a person skilled in the art that a variety of methods and materials are available to manufacture the new disk data storage media as contemplated herein as well as means to equip existing disk media with a data surface on its edge. Examples of materials, surface coatings, read/write apparatus and manufacturing techniques known to be useful in association with disk media and are taught in the following patents: U.S. Pat. No. 3,971,874 entitled “Optical information storage material and method of making it”, U.S. Pat. No. 4,064,521 entitled “Semiconductor device having a body of amorphous silicon”, U.S. Pat. No. 4,302,928 entitled “Updateable optical storage media”, U.S. Pat. No. 4,616,237 entitled “Data storage medium”, U.S. Pat. No. 4,998,238 entitled “Apparatus with multiple heads adjusted for optimum performance at different regions of optical disk”, U.S. Pat. No. 5,251,193 “Solid state optical disk reader”, U.S. Pat. No. 5,635,114 entitled “Method of making thin film optical storage media”, U.S. Pat. No. 5,734,633 entitled “Optical disk recording and reproducing apparatus and method using an optical disk for recording information on lands and grooves”, U.S. Pat. No. 5,881,044 entitled “Optical disk write/read apparatus and optical disk write method”, U.S. Pat. No. 6,058,086 entitled “Method and apparatus for testing quality of an optical disk medium”, U.S. Pat. No. 6,077,582 entitled “Optical disc process for producing the optical disk and its manufacturing apparatus”, U.S. Pat. No. 6,091,700 entitled “Optical disk and optical disk fabrication method”, U.S. Pat. No. 6,243,354 entitled “Optical disk having high recording density”, U.S. Pat. No. 6,288,997 entitled “Phase change optical disk medium”, U.S. Pat. No. 6,295,262 entitled “Method and apparatus for recording information onto optical disk” and U.S. Pat. No. 6,298,138 entitled “Optical disk, and optical disk barcode forming method, an optical disk reproduction apparatus, a marking forming apparatus, a method of forming a laser marking on an optical disk and a method of manufacturing an optical disk”. Those interested in related tracking and related data methods are referred to U.S. Pat. No. 6,219,197 entitled “Method and apparatus for servo positioning in a direct access storage device with a transducer read element width greater than 1/3 and less than V₂ the width of a data cylinder” and U.S. Pat. No. 5,926,337 entitled “Off-track correcting method disk apparatus and a disk apparatus using the same”.

Although the present invention has been described in some detail by way of example for purposes of clarity and understanding, it will be apparent that certain changes and modifications may be practised within the scope of the appended claims.

I claim:

1. Disk data storage media comprising a disk having first and second disk surfaces and an edge surface with at least one of said first and second disk surfaces and said edge surface being formed to store data.

2. Disk data storage media as claimed in claim 1 in which the disk edge surface stores data magnetically.

3. Disk data storage media as claimed in claim 1 in which the disk edge surface stores data optically.

4. Disk data storage media as claimed in claim 1 in which the disk edge surface stores data magneto-optically.

5. Disk data storage media as claimed in claim 1 in which the disk edge surface stores data by inscribed markings.

6. Disk data storage media as claimed in claim 1 in which data is imparted to the disk edge surface in a process selected from the group consisting of physical, magnetic, kinetic, thermal and optical processes.

7. Disk data storage media as claimed in claim 1 in which the disk edge surface is readable and writable.

8. Disk data storage media as claimed in claim 1 in which the disk edge surface is read only.

9. Disk data storage media as claimed in claim 1 in which the disk edge surface is enlarged.

10. Disk data storage media as claimed in claim 9 in which the enlarged disk edge surface is formed by increasing the thickness of the disk adjacent the disk edge.

11. Disk data storage media as claimed in claim 9 in which the enlarged disk edge surface is formed by creating an angled annular surface extending from at least one of the first and second disk surfaces.

12. Disk data storage media as claimed in claim 11 including a pair of opposed, angled surfaces that define a generally triangular cross-section having an apex at the edge surface of the disk.

13. Disk data storage media as claimed in claim 9 in which the enlarged disk edge surface is formed by an angled surface extending from the first to the second disk surfaces.

14. Disk data storage media as claimed in claim 9 in which the enlarged disk edge surface is formed by an annular flange extending from at least one of the first and second disk surfaces.

15. Disk data storage media as claimed in claim 1 in which the edge surface is formed with at least two layers, each layer being adapted to store data.

16. Disk data storage media as claimed in claim 1 in which the disk edge surface includes data to permit monitoring of physical characteristics of the disk and the movement of the disk.

17. Disk data storage media as claimed in claim 16 in which the disk edge surface includes data to permit monitoring of the tilt, vibration or rotation speed of the disk.

18. Disk data storage media as claimed in claim 1 in which the disk edge surface is formed to receive material having a surface to store data.

19. Disk data storage media as claimed in claim 18 in which the disk edge surface is formed with a groove to receive a band of material having a surface to store data.

20. Disk data storage media as claimed in claim 1 including at least one wire bonded to the disk edge surface, said at least one wire being used to store data.

21. In disk data storage media having first and second disk surfaces and an edge surface, the improvement comprising forming of the disk edge surface to store data.

22. A method of storing additional data on disk data storage media in the form of a disk with first and second disk surfaces having at least one data storage surface comprising storing data on the edge surface of the disk.

23. A method of providing additional data storage capacity on disk data storage media in the form of a disk with first and second disk surfaces, comprising the step of forming a data storage surface on the edge surface of the disk.

24. The method as claimed in claim 23 in which the step of forming a data storage surface on the edge surface of the disk includes the steps of:
preparing the edge surface of the disk; and
applying a surface for storage of data to the edge surface.

25. The method as claimed in claim 24 in which the step of applying a surface comprises:
rotating the disk; and
coating the disk with a surface to store data.

26. The method as claimed in claim 25 in which the step of coating the surface comprises spraying the data storage surface onto the edge surface.

27. The method as claimed in claim 24 in which the step of applying a surface comprises bonding material with a data storage surface to the edge surface.

28. The method as claimed in claim 24 in which the step of applying a surface comprises bonding a ring of material with a data storage surface to the edge surface.

29. The method as claimed in claim 28 including the step of forming a groove in the edge surface to receive the ring of material.

30. A method of converting disk data storage media in the form of a disk with first and second disk surfaces into a disk with additional storage comprising the steps:
preparing the edge surface of the disk; and
applying a surface for storage of data to the edge surface.

31. A method of forming disk data storage media comprising the steps:
mounting a pair of disk platters back to back to define an annular perimeter space therebetween; and
mounting a data storage surface in the perimeter space to define an edge surface.
